(19) United States
(12) Patent Application Publication
(10) Pub. No.: US 2006/0022366 A1
(43) Pub. Date: Feb. 2, 2006

(54) Method of producing polystyrene-based resin foam street

(76) Inventors: Akira Iwamoto, Utsunomiya-shi (JP); Kenichi Takase, Utsunomiya-shi (JP); Takashi Kawada, Utsunomiya-shi (JP); Hajime Ohta, Yokkaichi-shi (JP)

Correspondence Address: George A. Loud, Esquire;BACON & THOMAS, 625 Slaters Lane, Fourth Floor, Alexandria, VA, 22314-1176, US

(21) Appl. No.: 10/901,115

(22) Filed: Jul. 29, 2004

(51) Int. Cl. B29C 44/20

(52) U.S. Cl. 264/45.9; 264/53

(57) ABSTRACT

A method of producing a polystyrene-based resin foam sheet, including kneading a polystyrene-based resin and a physical blowing agent with heating in an extruder to obtain a foamable resin composition, and extruding the foamable composition through a die, wherein the physical blowing agent comprises 60 to 95 mole % of a first blowing agent selected from isobutane, n-pentane, isopentane and mixtures thereof and 5 to 40 mole % of a second blowing agent selected from water, carbon dioxide, ethers having a boiling point of 140° C. or lower, dialkylcarbonates having a boiling point of 140° C. or lower and mixtures thereof, and wherein the total mole % of the physical blowing agent is equal to 100 mole %.

### BACKGROUND OF THE INVENTION

1. Field of the Invention

This invention relates to a method of producing a polystyrene-based resin foam sheet suitable for the production of thermoformed products, such as containers, cups, boxes and trays by thermoforming operations.

2. Description of Prior Art

Because polystyrene-based resin foam sheets are excellent in thermoformability and give light-weight thermoformed articles having beautiful appearance and excellent heat insulating properties, they are now used in a large amount for the production of containers, cups or trays for foods. Such polystyrene-based resin foam sheets are generally produced by extrusion. Thus, a polystyrene-based resin is melted in an extruder and kneaded with a blowing agent and a cell size controlling agent such as talc. The resulting foamable resin composition is then extruded through a die into the atmosphere to obtain a foam sheet. Because of low costs and good secondary expansion properties, industrial grade butane generally containing about 70% of n-butane (normal butane) and about 30% of isobutane has been hitherto used as the blowing agent.

When industrial grade butane is used as a blowing agent, the amount of the blowing agent remaining in the cells of the foam sheet is considerably reduced within a short time, since n-butane relatively quickly permeates through the cell walls and is released to the atmosphere. Such a reduction of the residual amount of the blowing agent adversely affects the secondary expansion efficiency of the foam sheet that is necessary for the foam sheet to further expand in the thickness direction during thermoforming operations. Stated otherwise, the use of industrial grade butane as a blowing agent poses a problem that the “sheet life” (period of time during which a foam sheet exhibits satisfactory secondary expansion efficiency and provides suitable thickness of thermoformed products) is short.

To cope with this problem, Japanese Examined Patent Publication No. JP-B-H05-42977 proposes the use of a blowing agent composed of 70-100% by weight of isobutane having a relatively slow permeation speed and 0-30% by weight of n-butane having a relatively fast permeation speed. Because the amount of residual isobutane remaining in the foam sheet is large and because isobutane serves to act as a plasticizer of polystyrene resins, however, surfaces of thermoformed products obtained therefrom are roughened so that the surface appearance and surface printability are poor. Therefore, it is necessary for the foam sheet to be aged for a long period of time prior to thermoforming operations in order to obtain a suitable residual amount of the blowing agent. Due to the aging and storage costs, therefore, the cost of the foam sheet increases.

Japanese Unexamined Patent Publication No. JP-A-H07-165969 discloses a method of producing a foam sheet in which a resin composition composed of a polystyrene-based resin and a blowing agent containing greater than 30% by weight but not greater than 50% by weight of n-butane and less than 70% by weight but not less than 50% by weight of isobutane is extruded through a die such that a specific relationship is established between a density of the foam sheet and a density of a surface layer of the foam sheet. Because of an increased amount of n-butane as compared with that used in the method of JP-B-H05-42977, the method of JP-A-H07-165969 does not require a long aging time. Further, because of the specific density characteristic, the foam sheet is free of surface roughness. However, this method has been found to have the following problems.

First, the method requires a storage period of about 3 or 4 weeks in the cold season, although an aging time of about 2 weeks is sufficient in the hot season. The reason for this is that the permeation speed of n-butane through a polystyrene-based resin is much lower than that of air, i.e. only ⅛ of the permeation speed of air, although the permeation speed of n-butane is much higher as compared with isobutane.

Second, in the case of the foam sheet wound into a roll, a two-week aging time is insufficient to make the secondary expansion efficiency and thermoformability of the foam sheet uniform throughout the roll. Namely, the secondary expansion efficiency and thermoformability of the foam sheet obtained by the method of JP-A-H07-165969 vary in both the axial and radial directions of the roll. For example, in the case of a roll having an annular cross-section, both outside and inside peripheral surface regions and both side edge regions which are near to ambient atmosphere have secondary expansion efficiency and thermoformability different from those in the inner regions remote from ambient atmosphere. As a consequence, the thermoformed products obtained from the rolled sheet have different thicknesses and qualities.

The reason for the variation in secondary expansion efficiency and in thermoformability is considered to be that the amount of the residual blowing agent in the cells of the foam sheet varies in the radial direction and in the axial direction of the roll. Namely, whilst isobutane, whose permeation speed through a polystyrene-based resin is much lower than air, is hardly released from the cells during the aging stage, n-butane is gradually released from the cells of the foam sheet. In this case, surface portions of the roll located adjacent to ambient atmosphere lose n-butane much faster than inner portions remote from ambient atmosphere. Thus, the amount and composition of the blowing agent become different between the surface portions and inner portions of the roll, resulting in the variation in thermoformability and in secondary expansion efficiency.

Another reason is considered to be ascribed to rapid ingress of air into the cells in both side edge regions of the roll, which results in a slight expansion of the foam sheet in the radial direction of the roll so that the wound layers of the roll are pressed to each other to partly or entirely stop or narrow fluid passages between adjacent layers. Thus, n-butane cannot easily pass between adjacent wound layers to cause variation of the amount of n-butane and the resulting variation in secondary expansion efficiency and in thermoformability.

### SUMMARY OF THE INVENTION

It is, therefore, an object of the present invention to provide a method which has overcome the above problems of the conventional methods and which is capable of producing a polystyrene-based resin foam sheet suitable for the production of containers, cups or trays by thermoforming operations.

Another object of the present invention is to provide a method capable of producing a polystyrene-based resin foam sheet which does not require a long aging time and which has a long sheet life.

It is a further object of the present invention to provide a method capable of producing a polystyrene-based resin foam sheet which, even when wound into a roll, can be suitably subjected to thermoforming operations after aging for about 10 days to 2 weeks even in the cold season and can produce thermoformed products having uniform quality and thickness irrespective of the position of the foam sheet in the wound state.

In accomplishing the foregoing object, there is provided in accordance with the present invention a method of producing a polystyrene-based resin foam sheet, comprising the steps of:

kneading a polystyrene-based resin and a physical blowing agent with heating in an extruder to obtain a foamable resin composition; and

extruding the foamable composition through a die,

said physical blowing agent comprising 60 to 95 mole % of a first blowing agent selected from the group consisting of isobutane, n-pentane, isopentane and mixtures thereof and 5 to 40 mole % of a second blowing agent selected from the group consisting of water, carbon dioxide, ethers having a boiling point of 140° C. or lower, dialkylcarbonates having a boiling point of 140° C. or lower and mixtures thereof, wherein the total mole % of the physical blowing agent is equal to 100 mole %.

Other objects, features and advantages of the present invention will become apparent from the detailed description of the preferred embodiments of the invention to follow.

### DETAILED DESCRIPTION OF THE PREFERRED EMBODIMENTS OF THE INVENTION

In the method according to the present invention, a polystyrene-based resin and, if desired, one or more additives are heated, melted and kneaded in an extruder, to which a physical blowing agent is fed under a pressure. The resulting mixture in the extruder is further kneaded to obtain a foamable resin composition. The resin composition in a pressurized state in the extruder is, after being cooled to a temperature suitable for giving a foam sheet having a desired closed cell structure when released to ambient atmosphere, extruded, generally continuously, through a die attached to the extruder into a lower pressure zone, generally into ambient atmosphere, to obtain a foam sheet. For reasons of good production efficiency, it is preferred that the foamable resin be extruded through a circular die. The resulting tubular extrudate is then longitudinally cut to obtain a foam sheet. If desired, a T-die may be used for extruding the foamable resin composition therethrough.

As used herein, the term “polystyrene-based resin” is intended to refer to a homopolymer of styrene, a copolymer of styrene and one or more comonomers, a mixture of a styrene homopolymer with a styrene copolymer, a mixture of two or more styrene copolymers, a mixture of a styrene homopolymer and/or a styrene copolymer with a styrene-butadiene block copolymer, a rubber-modified styrene resin (impact resistant polystyrene resin) obtained by polymerizing styrene in the presence of a rubber polymer, or a mixture of at least one of the above homopolymer, copolymer, mixtures and rubber-modified styrene resin with one or more other polymers such as a thermoplastic resin. The above styrene may have one or more substituents such as alkyl groups and halogen atoms.

The polystyrene-based resin generally has at least 50% by weight of styrene component content.

When the polystyrene-based resin is desired to show an improvement in brittleness, a mixture of a styrene polymer (styrene homopolymer and/or styrene copolymer) with a polyphenylene ether, a styrene-conjugated diene block copolymer or an impact resistant polystyrene resin is suitably used. When the polystyrene-based resin is a mixture of a styrene polymer with a polyphenylene ether, the styrene component content is generally at least 25% by weight. In particular, a mixture of 90-30% by weight of a styrene polymer and 10-70% by weight of a polyphenylene ether is suitably used as a polystyrene-based resin for the production of a low expansion ratio foam sheet having an apparent density of 150-700 kg/m³.

Examples of the above comonomer include acrylic acid, methacrylic acid, maleic anhydride, butadiene and acrylonitrile.

It is preferred that the polystyrene-based resin preferably have a Vicat softening point of 100° C. or higher for reasons of improved thermal resistance of the foam sheet produced therefrom. The upper limit of the Vicat softening point is not specifically limited but is generally 150° C. The Vicat softening point is a value obtained according to JIS K7206-1991 (test load: Method A, heating rate of the fluid heating method: 50° C./hr).

The additives optionally incorporated into the foamable resin composition may be, for example, a nucleating agent, an anti-oxidizing agent, a heat stabilizer, an antistatic agent, an electroconductivity imparting agent, a weatherability agent, a UV absorbing agent, a flame retardant, an inorganic filler and a chemical blowing agent.

The nucleating agent serves to control the cell size of the foam sheet and may be an inorganic powder. Specific examples of the nucleating agent include talc, kaolin, mica, silica, calcium carbonate, barium sulfate, titanium oxide, clay, aluminum oxide, bentonite, diatomaceous earth, sodium bicarbonate and monosodium citrate. Above all, talc is particularly preferably used for reasons of inexpensiveness and effectiveness of cell size control. It is preferred that the inorganic powder have an average particle diameter (determined by centrifugal sedimentation method) of 30 μm or less, more preferably 20 μm or less, most preferably 15 μm or less, since the smaller the particle size, the smaller becomes the cell size of the foam sheet and the smaller can be the amount of the inorganic powder used. From the standpoint of the production costs, the average particle diameter of the inorganic powder is 0.1 μm or more.

In the method of the present invention, it is important that the physical blowing agent should include 60 to 95 mole % of a first blowing agent selected from isobutane, n-pentane, isopentane and mixtures thereof and 5 to 40 mole % of a second blowing agent selected from water, carbon dioxide, ethers having a boiling point of 140° C. or lower, dialkylcarbonates having a boiling point of 140° C. or lower and mixtures thereof, wherein the total mole % of the physical blowing agent is equal to 100 mole %, in order to produce a polystyrene-based resin foam sheet which is suitable for the production of containers, etc. by thermoforming operations, which has a long sheet life, which, even when wound into a roll, can be suitably subjected to thermoforming operations after aging for about 10 days to 2 weeks even in the cold season, and which can produce thermoformed products having uniform quality and thickness irrespective of the position of the foam sheet in the roll. The method of the present invention is particularly effective for the production of a foam sheet which is stored and aged in a state wound into a roll, in particular, a roll having a large diameter. Thus, the foam sheet preferably has a length along the extrusion direction (longitudinal direction) of at least 150 m, more preferably 160 to 650 m, most preferably 180 to 450 m.

Although not wishing to be bound by the theory, the above effects of the present invention are considered to be achieved by the following mechanism. The second blowing agent shows much higher permeation speed through the polystyrene-based resin as compared with that of air and is rapidly released from the foam sheet immediately after the extrusion. Therefore, the inside pressure within the cells immediately after the extrusion is lower than that in the case of the conventional methods in which isobutane is used by itself or in combination with n-butane. Therefore, the pressure exerted between adjacent layers of the roll is lower as compared with that in the case of the conventional methods so that fluid passages are ensured therebetween. Thus, air can pass between adjacent wound layers so that the amount of air in the cells generally reaches nearly equilibrium about 10 days after the production of the foam sheet. Since the use of the second blowing agent can reduce the amount of the first blowing agent, thermoformed products obtained from the foam sheet have good surface appearance. Among the second blowing agent, water is particularly preferably used.

Since the first blowing agent, i.e. isobutane, n-pentane and/or isopentane, has a much lower permeation rate as compared with n-butane, the residual amount of the first blowing agent in the foam sheet is kept nearly constant for a long period of time (up to about 6 months after the production) and does not vary with the position of the foam sheet when wound into a roll. Among the first blowing agent, isobutane is preferable for reasons of high expansion power of the foam sheet in thermoforming.

The composition of a gas contained in cells of the foam sheet prepared by the method of the present invention is stabilized within a relatively short period of time after the production thereof and does not vary thereafter for a long period of time. Therefore, the foam sheet has good sheet life. Further, when the foam sheet is wound to form a roll, the gas composition in the cells does not vary with the position in the roll. Therefore, the foam sheet can produce thermoformed products having uniform quality and thickness.

The total amount of the first blowing agent and the second blowing agent is at least 80 mole %, more preferably at least 85 mole %, still more preferably at least 90 mole %, most preferably at least 95 mole %, based on the total mole % of the physical blowing agent. In addition to the first and second blowing agents, the physical blowing agent may contain one or more other blowing agents, if desired. Such an additional blowing agent may be, for example, nitrogen, methane, ethane or propane and may be used in an amount of 25 mole % or less, preferably 20 mole % or less, still more preferably 15 mole % or less, yet still more preferably 10 mole % or less, most preferably 5 mole % or less, based on the total mole % of the physical blowing agent.

Although n-butane, propane or other blowing agent having a similar penetration speed through a polystyrene-based resin (e.g. about ⅛ of that of air) may be contained in the physical blowing agent, the amount thereof is desired to be up to 10 mole %, more preferably up to 5 mole %. The foamable resin composition used in the method of the present invention can contain a chemical blowing agent, although the amount thereof is desired to be as low as 0.01 to 1 part by weight per 100 parts by weight of the polystyrene-based resin.

The ether used as the second blowing agent preferably has a boiling point of −30 to 100° C., more preferably −30 to 40° C. Specific examples of the ether include methyl ethyl ether, dimethyl ether, diethyl ether and mixtures thereof. The dialkylcarbonate used as the second blowing agent preferably has a boiling point of −10 to 130° C. Specific examples of the dialkylcarbonate include dimethyl carbonate, diethyl carbonate, diisopropylcarbonate and mixtures thereof.

When the amount of the first blowing agent exceeds 95 mole % or when the amount of the second blowing agent is less than 5 mol %, the resulting foam sheet at an early stage of aging (about 10 days after the production of the foam sheet) fails to produce thermoformed products having good surface appearance. When the amount of the first blowing agent is less than 60 mole % or when the amount of the second blowing agent exceeds 40 mol %, it is difficult to produce a flat foam sheet.

For the purpose of producing a foam sheet having a suitable apparent density of 60 to 420 kg/m³, the physical blowing agent is desirably present in the foamable resin composition in the extruder in an amount satisfying the following condition:
40 mole/m³≦α×d≦90 mole/m³
wherein α represents a mole number (mole/kg) of the physical blowing agent per 1 kg of the polystyrene-based resin, and d represents an apparent density (kg/m³) of the polystyrene-based resin foam sheet.

For the same reasons, the first blowing agent is desirably present in the foamable resin composition in the extruder in an amount satisfying the following condition:
25 mole/m³≦β×d≦80 mole/m³
wherein β represents a mole number (mole/kg) of the first blowing agent per 1 kg of said polystyrene-based resin, and d represents an apparent density (kg/m³) of the polystyrene-based resin foam sheet.

The polystyrene-based resin foam sheet obtained by the method of the present invention generally has an apparent density of 60 to 420 kg/m³, preferably 70 to 350 kg/m³, more preferably 75 to 300 kg/m³. The apparent density herein is determined by dividing the basis weight of the foam sheet by the thickness thereof. The foam sheet obtained by the method of the present invention generally has a thickness of 0.5 to 5 mm, preferably 0.5 to 3.5 mm, more preferably 0.7 to 3 mm. The thickness herein is an arithmetic mean of thicknesses at 10 laterally (in the direction normal to the extrusion direction) equally spaced apart positions of the foam sheet.

The foam sheet obtained by the method of the present invention preferably has an open cell content of 0 to 15% more preferably 0 to 10%. The open cell content of the foam sheet is obtained according to ASTM D-2856-70 (Procedure C) as follows. The true volume Vx (cm³) of a sample of the foam sheet is measured with an air comparison pycnometer, and the closed cell content is calculated by the formula (1). The apparent volume Va (cm³) of the sample is the volume calculated from the outer dimension thereof. The true volume Vx (cm³) of the sample is the sum of a volume of the base resin constituting the foam and the total volume of all the closed cells in the sample. Thus, the open cell content is obtained by the following formula (1).
Open cell content (%)={(Va−Vx)/(Va−W/ρ)}×100 (1)
wherein W represents the weight (g) of the sample, and ρ represents the density (g/cm³) of the base resin of the foam.

In the measurement of open cell content, a rectangular solid piece with a size of 25 mm long×25 mm wide×40 mm thick is used as a sample. Thus, a number of the foam sheets are stacked so that the thickness is close to 40 mm but not exceeds 40 mm. 10 pieces of such samples are prepared. The open cell content of the present invention is an arithmetic mean of measured values of the ten samples.

The foam sheet obtained by the method of the present invention preferably has the following average cell size characteristics:
0.3≦X/Y≦1.0
0.3≦X/Z≦1.0
60 μm≦(X+Y+Z)/3≦100 μm
wherein X represents the average cell size in the thickness direction, Y represents the average cell size in the extrusion (longitudinal) direction and Z represents the average cell size in the transverse direction. Each of the ratios X/Y and X/Z is more preferably 0.4 to 0.8.

The average cell sizes X, Y and Z of a foam sheet are determined from photographs of longitudinal and transverse cross-sections of the foam sheet using a microscope. Thus, to obtain the average cell size Y in the extrusion direction, a longitudinal cross-section of the foam sheet is photographed with the microscope. On the magnified photograph, three straight lines each parallel with the surface of the foam sheet and each having a fixed length corresponding to 2 mm before magnification are drawn. One of the three lines extends near the center in the thickness thereof while the other two lines extend near the upper and lower surfaces of the foam sheet. Then, the number of cells falling along each of the straight lines is counted. In this case, a cell only a portion of which is passed by the straight line should be included in count. Average cell sizes Y1, Y2 and Y3 (mm) along the three straight lines are calculated as [2/(n−1)] in which n is the cell count number along respective straight lines. The average cell size Y is calculated as follows:
Y(mm)=(Y1+Y2+Y3)/3.

The average cell size X in the thickness direction is also determined from the above magnified photograph of the longitudinal cross-section. A straight line in the thickness direction is drawn. The number (n) of cells falling along the straight line is counted. The average cell size X (mm) is calculated according to the formula
X(mm)=(T/n)
wherein T is the thickness (mm) of the foam sheet and n is the cell count number.

The average cell size Z in the transverse direction is determined from a magnified photograph of a transverse cross-section of the foam sheet in the same manner as that for the determination of the average cell size Y.

It is preferred that the foamable resin composition be cooled with a cooling medium such as water or air as soon as it has been extruded from a die, so that opposite side surface regions thereof are prevented from freely expanding and foaming and the resulting polystyrene-based resin foam sheet has opposite surface layers each having an apparent density higher than that of the whole foam sheet. In particular, the apparent density of each of the surface layers is preferably 1.3 to 3.5 times, more preferably 1.5 to 3.0 times as high as that of the whole foam sheet.

The apparent density of the surface layers is measured as follows. A foam sheet to be measured is cut into strips each having a length of 20 mm, a width of 5 mm and a thickness equal to that of the foam sheet. From each strip, a surface layer with a depth of 200 μm is sliced from one side thereof to obtain a sample having a length of 20 mm, a width of 5 mm and a thickness of 200 μm. Similar procedures are repeated to obtain 10 samples sliced from one side of the foam sheet and another 10 samples sliced from the other side of the foam sheet. Each of the 20 samples thus obtained is weighed, from which the apparent density is calculated. The apparent density of the surface layers is an arithmetic mean of those of the 20 samples.

If desired, the polystyrene-based resin foam sheet may be composited with a film or a sheet of any desired material. Thus, for example, one or both sides of the foam sheet may be laminated with a non-foamed thermoplastic resin film or sheet to obtain a laminate having improved thermoformability and mechanical properties such as rigidity and tear strength. Such a laminate may be prepared by a bonding method in which a film or sheet is bonded to a foam sheet by fuse bonding or with an adhesive; by an extrusion laminating method in which a film or sheet extruded through a die is laminated on a foam sheet extruded through another die; or by a coextrusion method in which a foamable resin composition and a non-foamable resin composition are coextruded through a multi-layered die. The thickness of the film or sheet laminated on the foam sheet is not specifically limited but is generally 0.01 to 0.3 mm.

Examples of the thermoplastic resin of the non-foamed film or sheet include polyethylene-based resins such as high density polyethylene, low density polyethylene, linear low density polyethylene and ethylene-vinyl acetate copolymers; polystyrene-based resins such as styrene homopolymer and impact resistant polystyrene; polypropylene-based resins; and polyester resins. A non-foamed polystyrene-based resin film or sheet is particularly suitably used for reasons of easiness in bonding to the foam sheet.

The polystyrene-based resin foam sheet and a laminate of the foam sheet and a non-foamed film or sheet may be subjected to thermoforming operations using male and/or female molds. The thermoforming may be performed by any conventional molding method such as air-pressure forming, vacuum forming such as matched mold forming, straight forming, drape forming, reverse draw forming, air slip forming, plug assist forming, plug assist reverse draw forming or any suitable combinations of the above.

The following examples will further illustrate the present invention.

### EXAMPLE 1

In a first extruder having a diameter of 90 mm, 100 parts by weight of a polystyrene-based resin (Trade name: HH32, manufactured by Idemitsu Petrochemical Co., Ltd., MI: 1.6 g/10 min (200° C., 49.03 N)) and 1 part by weight of talc were placed and kneaded with heating. Then, a physical blowing agent having a composition shown in Table 1 was fed to the first extruder in an amount shown in Table 1 and the contents in the first extruder were further kneaded. The kneaded mixture was passed to a second extruder having a diameter of 120 mm and cooled to the extrusion temperature shown in Table 1. The foamable resin composition thus obtained was extruded through a circular die attached to the second extruder. The resulting foamed and expanded tubular extrudate was received over a cooled mandrel (diameter of 333 mm) disposed in a cooling device. The cooled tubular extrudate was then longitudinally cut to obtain a foam sheet. The foam sheet was wound around a rotating mandrel having an outer diameter of 266 mm to obtain a roll of the foam sheet having a length of 200 m. The mandrel was then extracted to leave a foam sheet roll having an annular cross-section. The above operation was repeated to obtain a plurality of similar foam sheet rolls.

### EXAMPLES 2-6 AND COMPARATIVE EXAMPLES 1-4

Example 1 was repeated in the same manner as described except that the composition and amount of the physical blowing agent were changed as shown in Table 1 and that the resin temperature in the second extruder was changed as shown in Table 1.

Each of the foam sheets obtained in Examples 1-6 and Comparative Examples 1-4 was measured for the thickness (mm), basis weight (g/m²), apparent density d (kg/m³), density of the surface layer (g/cm³), total residual amount of organic blowing agents (mol/kg), residual amount of isobutane (mol/kg), secondary expansion efficiency in terms of expansion ratios A-C, uniformity in quality (Q10, Q10′) of thermoformed products obtained from the foam sheet, surface roughness, open cell content (%) and average cell size characteristics X/Y, X/Z and (X+Y+Z)/3. The results are summarized in Table 2. In Example 4, the residual amount of isopentane was 0.11 mol/m³. In Example 6, the residual amount of dimethyl ether was 0.01 mol/m³.

The residual amount of organic blowing agents, secondary expansion efficiency, uniformity in quality and surface roughness are measured as follows.

Measurement of Residual Amount of the Blowing Agent:

A sample piece is cut off from an extruded foam sheet 30 minutes after the production of the foam sheet and is put in a sample bottle with a lid, in which toluene is contained. After addition of an internal standard substance (cyclopentane), the bottle is closed with a lid and is sufficiently shaken so that the blowing agents in the sample piece may be dissolved in the toluene, thereby obtaining a measuring sample liquid. By performing gas chromatography on the sample liquid, the residual amounts (in terms of % by weight) of organic blowing agents are determined according to the following formula.
Xᵢ=(Fᵢ×Aᵢ×Wₛ×100)/(Aₛ×Wₛₘ)
Xᵢ: concentration in % by weight of the target blowing agent
Fᵢ: correction factor
Aₛ: peak area of the standard substance
Aᵢ: peak area of the target blowing agent
Wₛ: weight of the standard substance
Wₛₘ: weight of the sample

The gas chromatogram is GC-14B manufactured by Shimadzu Corporation and measuring conditions chromatography are as follows.
Column: Silicone DC 550 manufactured by Shimadzu Corporation, 20% on Chromosorb W AW-DMCS 60/80 mesh, 4.1 m×3.2 mm
Column temperature: 40° C.
Detector temperature: 180° C.
Inlet temperature: 180° C.
Detector: FID
Carrier gas: nitrogen, 140 ml/min
Sample: 2 μl
   Measurement of Secondary Expansion Efficiency:

The foam sheet having a length of 200 m is wound into a roll and is aged at 23° C. under a relative humidity of 50% for 10 days (from the production of the foam sheet). A square sample (260 mm×260 mm) is then cut from the outermost layer of the aged roll and measured for the thickness (A1). A marginal portion of the sample is fixed to a wooden frame having an inside square opening (200 mm×200 mm). The frame having the attached foam sheet is placed in a thermostat (PERFECT OVEN ORIGINAL Ph-200 manufactured by Tabai Espec Corp.) and heated at 145° C. for 27 seconds. After cooling to room temperature, the thickness A2 of the foam sheet is measured. The ratio A2/A1 represents the secondary expansion efficiency A of the outermost layer.

A square sample (260 mm×260 mm) is cut from a transverse center line portion of the foam sheet of the above aged roll at a position spaced a distance of 120 m from the outside end of the rolled sheet and measured for the thickness (B1). The sample is then heated in the same manner as in the measurement of the secondary expansion efficiency A and the thickness B2 of the foam sheet is measured. The ratio B2/B1 represents the secondary expansion efficiency B of the intermediate layer in the transverse center. Also a square sample (260 mm×260 mm) is cut from a transverse end (side end) portion of the foam sheet and the thicknesses C1 and C2 are measured in the same manner. The ratio C2/C1 represents the secondary expansion efficiency C in the intermediate layer at the side edge.

Evaluation of Uniformity of Quality:

The uniformity of quality of thermoformed products is evaluated in terms of Q10 and Q10′ calculated from the following equations:
Q10 (|(A−B)|/A×100
Q10′=(|(C−B)|/C×100
wherein A, B and C represents the secondary expansion efficiencies of the outermost layer, intermediate layer at the transverse center and intermediate layer at the side edge, respectively, measured as above. The smaller the absolute values Q10 or Q10′, the smaller is the variation in secondary expansion efficiency by location in the roll and, therefore, the better is the uniformity of the quality.
Measurement of Surface Roughness:

The foam sheet is aged at 23° C. under a relative humidity of 50% for 7 days (from the production of the foam sheet) and is thermoformed in the same manner as that for the measurement of the secondary expansion efficiency. The surface roughness is evaluated with naked eyes as follows:

good: no surface roughness is observed

bad: surface roughness is observed

Table 1
Extrusion Conditions

| | | | | | | | | Comparative | | | |
|---|---|---|---|---|---|---|---|---|---|---|---|
| | | Example | | | | | | Example | | | |
| | | 1 | 2 | 3 | 4 | 5 | 6 | 1 | 2 | 3 | 4 |
| Composition | Isobutane | 91 | 80 | 88 | 65 | 94 | 65 | 65 | 60 | 45 | 100 |
| of | n-Butane | — | — | — | — | — | — | 35 | 36 | 35 | — |
| physical | Isopentane | — | — | — | 13 | — | — | — | 4 | 20 | — |
| blowing | Dimethyl | — | 20 | — | — | 5 | 35 | — | — | — | — |
| agent | ether | | | | | | | | | | |
| (mole %) | Carbon | — | — | 12 | — | — | — | — | — | — | — |
| | dioxide | | | | | | | | | | |
| | Water | 9 | — | — | 22 | 1 | — | — | — | — | — |

| | | | | | | | | | | |
|---|---|---|---|---|---|---|---|---|---|---|
| Amount of physical | 0.67 | 0.78 | 0.70 | 0.79 | 0.66 | 0.90 | 0.71 | 0.74 | 0.77 | 0.80 |
| blowing agent α | | | | | | | | | | |
| (mol/kg) | | | | | | | | | | |
| Resin temperature (° C.) | 151 | 143 | 153 | 153 | 151 | 148 | 147 | 146 | 150 | 147 |
| α × d (mol/m³) | 61 | 70 | 53 | 75 | 83 | 72 | 66 | 67 | 68 | 74 |
| β × d (mol/m³) | 56 | 56 | 47 | 59 | 78 | 47 | 66 | 64 | 68 | 74 |

TABLE 2
Properties of Foam Sheet

| | | | | | | | | | | |
|---|---|---|---|---|---|---|---|---|---|---|
| Example | 1 | 2 | 3 | 4 | 5 | 6 | | | | |
| Comparative Example | | | | | | | 1 | 2 | 3 | 4 |
| Thickness (mm) | 2.20 | 2.00 | 2.50 | 1.90 | 1.60 | 2.50 | 2.15 | 2.00 | 2.50 | 2.15 |
| Basis weight (g/m²) | 200 | 180 | 190 | 180 | 200 | 200 | 200 | 180 | 220 | 200 |
| Apparent density d (kg/m³) | 91 | 90 | 76 | 95 | 125 | 80 | 93 | 90 | 88 | 93 |
| Surface density (kg/m³) | 0.20 | 0.20 | 0.18 | 0.21 | 024 | 0.18 | 0.20 | 0.20 | 0.19 | 0.20 |
| Residual amount of organic | 0.61 | 0.62 | 0.62 | 0.63 | 0.61 | 0.62 | 0.69 | 0.71 | 0.074 | 0.77 |
| blowing agent (mol/kg) | | | | | | | | | | |
| Residual amount of | 0.61 | 0.62 | 0.62 | 0.52 | 0.61 | 0.61 | 0.45 | 0.41 | 0.27 | 0.77 |
| isobutane (mol/kg) | | | | | | | | | | |
| Secondary expansion ratio | 2.13 | 2.15 | 2.12 | 2.27 | 2.28 | 2.13 | 2.27 | 2.25 | 2.12 | 2.15 |
| A (fold) | | | | | | | | | | |
| Secondary expansion ratio | 2.08 | 2.08 | 2.07 | 2.24 | 2.20 | 2.09 | 2.08 | 2.04 | 1.92 | 2.08 |
| B (fold) | | | | | | | | | | |
| Secondary expansion ratio | 2.12 | 2.10 | 2.12 | 2.25 | 2.27 | 2.12 | 2.24 | 2.21 | 2.08 | 2.12 |
| C (fold) | | | | | | | | | | |
| Uniformity of quality Q10 | 2.35 | 3.26 | 2.36 | 1.32 | 3.50 | 1.88 | 8.37 | 9.33 | 9.43 | 3.25 |
| Uniformity of quality Q10′ | 1.89 | 1.87 | 2.36 | 0.44 | 3.08 | 1.42 | 7.14 | 7.69 | 7.69 | 1.89 |
| Surface roughness | good | good | good | good | good | good | bad | bad | bad | bad |
| Open cell content (%) | 5 | 4 | 9 | 6 | 4 | 7 | 4 | 4 | 4 | 4 |
| Av. cell size ratio X/Y | 0.69 | 0.72 | 0.80 | 0.73 | 0.67 | 0.71 | 0.69 | 0.72 | 0.68 | 0.69 |
| Av. cell size ratio X/Z | 0.53 | 0.53 | 0.71 | 0.53 | 0.50 | 0.53 | 0.53 | 0.53 | 0.57 | 0.53 |
| Average cell size | 238 | 235 | 180 | 227 | 210 | 243 | 239 | 235 | 240 | 239 |
| (X + Y + Z)/3 (μm) | | | | | | | | | | |
| Average cell size X (μm) | 165 | 165 | 147 | 160 | 140 | 170 | 165 | 165 | 170 | 165 |
| Average cell size Y (μm) | 240 | 230 | 184 | 220 | 210 | 240 | 240 | 230 | 250 | 240 |
| Average cell size Z (μm) | 310 | 310 | 209 | 300 | 280 | 320 | 311 | 310 | 300 | 311 |

### EXAMPLES 7-12

In a first extruder having a diameter of 90 mm, 100 parts by weight of a resin or a resin composition shown in Table 3 and 1 part by weight of talc were placed and kneaded with heating. Then, a physical blowing agent having a composition shown in Table 3 was fed to the first extruder in an amount shown in Table 3 and the contents in the first extruder were further kneaded. The kneaded mixture was passed to a second extruder having a diameter of 120 mm and cooled to the extrusion temperature shown in Table 3. The foamable resin composition thus obtained was extruded through a circular die having a diameter of 110 mm and attached to the second extruder. The resulting foamed and expanded tubular extrudate was received over a cooled mandrel (diameter of 333 mm) disposed in a cooling device. The cooled tubular extrudate was then longitudinally cut to obtain a foam sheet. The foam sheet was wound around a rotating mandrel having an outer diameter of 266 mm to obtain a roll of the foam sheet having a length of 200 m. The mandrel was then extracted to leave a foam sheet roll having an annular cross-section. The above operation was repeated to obtain a plurality of similar foam sheet rolls.

In Table 3, “HH32” is a polystyrene resin (Trade name: HH32, manufactured by Idemitsu Petrochemical Co., Ltd.), “PKN4752” is a polystyrene-modified polyphenylene ether (Trade name: PKN4752, manufactured by Japan GE Plastic Co., Ltd., polystyrene/polyphenylene ether=30/70), and “TUFPRENE” is a styrene-butadiene-styrene copolymer (Trade name: TUFPRENE 125, manufactured by Asahi Kasei Chemicals Corporation).

TABLE 3
Extrusion Conditions

| Example | | 7 | 8 | 9 | 10 | 11 | 12 |
|---|---|---|---|---|---|---|---|
| Resin | HH32 | 100 | 75 | 65 | 30 | 80 | 100 |
| (% by weight) | PKN4752 | — | 25 | 35 | 70 | — | — |
| | TUFPRENE | — | — | — | — | 20 | — |
| Composition of | Isobutane | 85 | 89 | 85 | 91 | 80 | 62 |
| physical blowing | Water | 15 | 11 | — | 9 | — | 38 |
| agent (mol %) | Carbon dioxide | — | — | 15 | — | 20 | — |

| | | | | | | |
|---|---|---|---|---|---|---|
| Amount of physical blowing agent | 0.17 | 0.23 | 0.16 | 0.14 | 0.29 | 0.16 |
| α (mol/kg) | | | | | | |
| Amount of first blowing agent | 0.15 | 0.20 | 0.14 | 0.13 | 0.26 | 0.09 |
| β (mol/kg) | | | | | | |
| α × d (mol/m³) | 55 | 46 | 53 | 45 | 54 | 49 |
| β × d (mol/m³) | 48 | 40 | 47 | 41 | 48 | 27 |
| Resin temperature (° C.) | 165 | 187 | 191 | 203 | 161 | 170 |

The foam sheets obtained in Examples 7-12 were measured for the thickness (mm), basis weight (g/m²), apparent density d (kg/m³), secondary expansion efficiency in terms of expansion ratios A-C, uniformity in quality (Q10, Q10′), open cell content (%) and average cell size characteristics X/Y, X/Z and (X+Y+Z)/3 in the same manner as described previously. Further, the foam sheets were tested for isobutane contents after 10 days and 90 days from the production of the foam sheets, surface roughness, secondary expansion efficiency in terms of expansion ratios D-F, uniformity in quality (Q90, Q90′), sheet life, rigidity and impact resistance in the following manner.

Measurement of Isobutane Contents:

Foam sheet rolls are aged at 23° C. under a relative humidity of 50% for 10 days and 90 days from the production of the foam sheets. Samples are cut off from an outermost layer and an intermediate layer (at transverse center and at side edge) of each roll and is measured for isobutane content by gas chromatography in the same manner as described above.

Measurement of Surface Roughness:

Measurement is performed in the same manner as described above except that the aging time is increased to 10 days.

Measurement of Secondary Expansion Efficiency in Terms of Expansion Ratios D-F:

Except that the aging time is increased to 90 days after the production of the foam sheet, the measurements of secondary expansion efficiencies A-C are repeated for measuring secondary expansion efficiencies D-F, respectively.

Evaluation of Uniformity of Quality:

From the above secondary efficiencies D-F, Q90 and Q90′ are calculated according to the following formulas:
Q90=(|(D−E)|/D×100
Q90′=(|(F−E)|/F×100
Evaluation of Sheet Life:

Sheet life is evaluated from the data of secondary expansion efficiencies D-F. Thus, for the foam sheets having a basis weight of 350 g/m², the sheet life is evaluated as being good only when all secondary expansion efficiencies D-F are at least 1.6. For the foam sheets having a basis weight of 290 g/m², the sheet life is evaluated as being good only when all secondary expansion efficiencies D-F are at least 1.7. For the foam sheets having a basis weight of 240 and 250 g/m², the sheet life is evaluated as being good only when all secondary expansion efficiencies D-F are at least 2.0. If one or more of the secondary expansion efficiencies D-F do not meet with the above conditions, the foam sheet is evaluated as being bad.

Evaluation of Rigidity:

Foam sheet rolls are aged at 23° C. under a relative humidity of 50% for 10 days from the production of the foam sheet. A sample having a length of 10 cm and a width of 2.5 cm is then cut from the outermost layer of the aged roll at a transverse centerline portion and measured for bending modulus in accordance with JIS K7203 at a test speed of 10 mm/min. The rigidity is evaluated according to the following ratings:
Good: Bending modulus is 25 MPa or more
Bad: Bending modulus is less than 25 MPa
   Evaluation of Impact Resistance:

Foam sheet rolls are aged at 23° C. under a relative humidity of 50% for 10 days from the production of the foam sheet. A sample is then cut from the outermost layer of the aged roll at a transverse centerline portion and measured for 50% destruction energy by a dirt impact test in accordance with JIS K7124 (Method A). The impact resistance is evaluated according to the following ratings:
Good: 50% destruction energy is 250 mJ or more
Fair: 50% destruction energy is less than 250 mJ but not less than 100 mJ
Poor: 50% destruction energy is less than 100 mJ

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all the changes which come within the meaning and range of equivalency of the claims are therefore intended to be embraced therein.

TABLE 4
Properties of Foam Sheet

| Example | | 7 | 8 | 9 | 10 | 11 | 12 |
|---|---|---|---|---|---|---|---|
| Thickness (mm) | | 0.90 | 1.26 | 0.87 | 1.10 | 1.30 | 0.95 |
| Basis weight (g/m²) | | 290 | 250 | 290 | 350 | 240 | 290 |
| Apparent density d (kg/m³) | | 322 | 198 | 333 | 318 | 185 | 305 |
| Secondary expansion ratio A | | 2.15 | 2.25 | 2.14 | 1.93 | 2.28 | 2.03 |
| (fold) | | | | | | | |
| Secondary expansion ratio B | | 2.09 | 2.21 | 2.08 | 1.88 | 2.23 | 1.96 |
| (fold) | | | | | | | |
| Secondary expansion ratio C | | 2.11 | 2.24 | 2.11 | 1.90 | 2.26 | 1.99 |
| (fold) | | | | | | | |
| Uniformity of quality Q10 | | 2.79 | 1.78 | 2.80 | 2.59 | 2.19 | 3.45 |
| Uniformity of quality Q10′ | | 0.95 | 1.34 | 1.42 | 1.05 | 1.33 | 1.51 |
| Amount of | Outermost | 0.12 | 0.17 | 0.12 | 0.10 | 0.23 | 0.059 |
| residual isobutane | layer | | | | | | |
| after 10 days | Intermediate | 0.13 | 0.18 | 0.12 | 0.11 | 0.24 | 0.062 |
| (mol/kg) | layer, center | 0.12 | 0.17 | 0.12 | 0.11 | 0.24 | 0.060 |
| Surface roughness | | good | good | good | good | good | good |
| Secondary expansion ratio D | | 2.13 | 2.25 | 2.10 | 1.89 | 2.21 | 1.75 |
| (fold) | | | | | | | |
| Secondary expansion ratio E | | 2.12 | 2.20 | 2.06 | 1.87 | 2.22 | 1.79 |
| (fold) | | | | | | | |
| Secondary expansion ratio F | | 2.09 | 2.22 | 2.09 | 1.88 | 2.20 | 1.77 |
| (fold) | | | | | | | |
| Uniformity of quality Q90 | | 0.47 | 2.22 | 1.90 | 1.06 | 0.45 | 2.29 |
| Uniformity of quality Q90′ | | 1.44 | 0.90 | 1.44 | 0.53 | 0.91 | 1.13 |
| Amount of | Outermost | 0.11 | 0.17 | 0.11 | 0.095 | 0.22 | 16.8 |
| residual isobutane | layer | | | | | | |
| after 90 days | Intermediate | 0.12 | 0.17 | 0.11 | 0.11 | 0.23 | 17.7 |
| (mol/kg) | layer, center | | | | | | |
| | Intermediate | 0.11 | 0.17 | 0.11 | 0.10 | 0.23 | 17.1 |
| | layer, edge | | | | | | |

| | | | | | | |
|---|---|---|---|---|---|---|
| Sheet life | good | good | good | good | good | good |
| Open cell content (%) | 4 | 5 | 6 | 8 | 6 | 5 |
| Av. cell size ratio X/Y | 0.45 | 0.44 | 0.42 | 0.52 | 0.50 | 0.36 |
| Av. cell size ratio X/Z | 0.42 | 0.41 | 0.44 | 0.48 | 0.45 | 0.33 |
| Average cell size | 82 | 85 | 73 | 79 | 88 | 75 |
| (X + Y + Z)/3 (μm) | | | | | | |
| Average cell size X (μm) | 44 | 42 | 39 | 47 | 51 | 33 |
| Average cell size Y (μm) | 97 | 96 | 93 | 91 | 101 | 92 |
| Average cell size Z (μm) | 105 | 103 | 88 | 98 | 113 | 101 |
| Rigidity | good | good | good | good | good | good |
| Impact resistance | fair | good | good | good | good | fair |

What is claimed is:

1. A method of producing a polystyrene-based resin foam sheet, comprising the steps of:
kneading a polystyrene-based resin and a physical blowing agent with heating in an extruder to obtain a foamable resin composition; and
extruding the foamable composition through a die,
said physical blowing agent comprising 60 to 95 mole % of a first blowing agent selected from the group consisting of isobutane, n-pentane, isopentane and mixtures thereof and 5 to 40 mole % of a second blowing agent selected from the group consisting of water, carbon dioxide, ethers having a boiling point of 140° C. or lower, dialkylcarbonates having a boiling point of 140° C. or lower and mixtures thereof, wherein the total mole % of the physical blowing agent is equal to 100 mole %.

2. A method as claimed in claim 1, wherein said first blowing agent is isobutane and said second blowing agent is water.

3. A method as claimed in claim 1, wherein the total amount of said first blowing agent and said second blowing agent is at least 80 mole % based on the total mole % of said physical blowing agent.

4. A method as claimed in claim 1, wherein a total amount of said first blowing agent and said second blowing agent is at least 85 mole % based on the total mole % of said physical blowing agent.

5. A method as claimed in claim 1, wherein the total amount of said first blowing agent and said second blowing agent is at least 90 mole % based on the total mole % of said physical blowing agent.

6. A method as claimed in claim 1, wherein the total amount of said first blowing agent and said second blowing agent is at least 95 mole % based on the total mole % of said physical blowing agent.

7. A method as claimed in claim 1, wherein said physical blowing agent is present in said foamable resin composition in said extruder in an amount satisfying the following condition:
40 mole/m³≦α×d≦90 mole/m³
wherein α represents a mole number (mole/kg) of said physical blowing agent per 1 kg of said polystyrene-based resin, and d represents an apparent density (kg/m³) of the polystyrene-based resin foam sheet.

8. A method as claimed in claim 1, wherein said first blowing agent is present in said foamable resin composition in said extruder in an amount satisfying the following condition:
25 mole/m³≦β×d≦80 mole/m³
wherein β represents a mole number (mole/kg) of said first blowing agent per 1 kg of said polystyrene-based resin, and d represents an apparent density (kg/m³) of the polystyrene-based resin foam sheet.

9. A method as claimed in claim 1, further comprising winding the foam sheet to form a roll.
